(19) United States
(12) Patent Application Publication
(10) Pub. No.: US 2021/0034347 A1
(43) Pub. Date: Feb. 4, 2021

(54) AUTOMATED DEPLOYMENT OF SOFTWARE COMPONENTS

(71) Applicant: LinQuest Corporation, Los Angeles, CA (US)

(72) Inventor: Harold A. Robbins, Colorado Springs, CO (US)

(73) Assignee: LinQuest Corporation, Los Angeles, CA (US)

(21) Appl. No.: 16/527,545

(22) Filed: Jul. 31, 2019

(51) Int. Cl. G06F 8/61; G06F 8/658; G06F 8/71

(52) U.S. Cl. CPC G06F 8/63; G06F 8/71; G06F 8/658

(57) ABSTRACT

A method, a system, and a computer program product for automated deployment of software components. A request for one or more updates to one or more functionalities of a software application is received. The software application is installed on at least one user device. Based on the request, one or more updates to one or more functionalities of the software application are generated. The updates are generated in accordance with at least one runtime instance associated with the software application. The generated updates to one or more functionalities of the software application are compared with one or more previously stored functionalities of the software application. Based on the comparison, at least one generated update to one or more functionalities of the software application is selected for instantiation on the user device. The generated update is instantiated on the user device.

### TECHNICAL FIELD

In some implementations, the current subject matter relates to data processing systems, and in particular, to an automated deployment of computing/software components.

### BACKGROUND

In today's world, computing systems and device rely on various software applications for performance of various tasks. Software applications can include applications relating to email processing, document preparation, creation of graphics, video, and audio objects, as well as other relatively simple operations. The software applications may also be involved in operation of complex systems, such as telecommunication systems, satellite systems, machinery, assembly lines, etc. Periodically, software applications require updates to ensure their efficient operation as well as operations of computing systems on which they are installed.

Updating of software applications may be a complex process that typically requires downloading of the updates, installing the updates, and then rebooting of computing systems to ensure that updates take place. As part of the update process, many third-party software applications allow extension and/or customization of the application's functionality via construction of software components implemented using ActiveX™ technology. These ActiveX™ software components must be formally registered, using administrative privileges, on a client computing system to utilize the component's functionality. When enhancements are made, the process must be repeated on all client machines that have the component installed. This process can be disruptive to the operation of computing systems. Additionally, not all updates may be useful or actually be installed on all computing systems indiscriminately. If a wrong update is installed, it can cause a fatal error in operation of the corresponding computing system. Hence, this manual process may significantly delay installation of up-to-date software components on user devices and may increase a total cost of ownership of computing systems implementing such components. Thus, there is a need for a streamlined software application update process that ensures that proper updates are deployed with a minimum amount of disruption to the user computing systems.

### SUMMARY

In some implementations, the current subject matter relates to a computer implemented method for automated deployment of software updates. The method may include receiving a request for one or more updates to one or more functionalities of a software application, the software application being installed on at least one user device; generating, based on the received request, one or more updates to one or more functionalities of the software application, the updates being generated in accordance with at least one runtime instance associated with the software application; comparing the generated updates to one or more functionalities of the software application with one or more previously stored functionalities of the software application; selecting, based on the comparing, at least one generated update to one or more functionalities of the software application for instantiation on the user device; and instantiating the generated update on the user device.

In some implementations, the current subject matter can include one or more of the following optional features. In some implementations, the method may also include storing the generated update to the functionalities/components of the software application.

In some implementations, at least one repository may store the one or more updates to functionalities/components of the software application in accordance with a particular model. In some implementations, the comparison may also include determining that at least one generated update to functionalities/components of the software application is not included in one or more previously stored/cached functionalities/components of the software application, requesting generation of the determined update and receiving generated update for instantiation on the user device. The determined update may be generated by the repository in accordance with the model. The repository may generate a binary file associated with the determined update.

In some implementations, the method may also include receiving at least one function call for execution by at least one updated instantiated functionality/component on the user device, executing the instantiated functionality/component on the user device, and transmitting at least one result of the execution of the instantiated functionality on the user device.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for performing automated deployment of software components, according to some implementations of the current subject matter;

FIG. 2 illustrates an exemplary process performed during initialization of an automated instantiation of computing functionalities/components, according to some implementations of the current subject matter;

FIG. 3 illustrates an exemplary process performed during an operation phase of the automated instantiation of computing functionalities/components, according to some implementations of the current subject matter;

FIG. 4 illustrates an exemplary implementation of functionality/component initialization flow diagram, according to some implementations of the current subject matter;

FIG. 5 illustrates an exemplary system, according to some implementations of the current subject matter; and

FIG. 6 illustrates an exemplary method, according to some implementations of the current subject matter.

### DETAILED DESCRIPTION

To address these and potentially other deficiencies of currently available solutions, one or more implementations of the current subject matter relate to methods, systems, articles of manufacture, and the like that can, among other possible advantages, provide an automated way for deployment of one or more software functionalities/components.

Functionalities/components associated with software application are constantly evolving and frequently require updates (e.g., new versions of functionalities/components, software applications, etc.). One methodology for software vendors to allow end-users to expand the functionalities of commercial off-the shelf (COTS) products/applications is to provide an application programming interface (API), such as, an ActiveX™ API. The end-user writes a software component that uses that API. The APIs may be used with various computing functionalities/components, including custom functionalities/components. Thus, when construction of such custom functionalities/components is complete, they are registered on the end-user computer that executes the COTS application. When running, the COTS application will encounter pre-defined events that will cause it to use one of the custom functionalities'/components' functions.

The construction of such APIs, e.g., ActiveX™ APIs, include definitions of immutable interfaces and registration of such interfaces in the computer's operating system (e.g., Windows™ computer's registry). The registration of the COTS application's immutable ActiveX™ APIs is performed when the COTS application is installed. This is a first registration process.

When an end-user wants to expand the functionality of the COTS application, a component that uses that published API may be generated. The generated component is then registered on the computer's operating system. This second registration identifies a location of the generated component, as well as, a list of ActiveX™ APIs that it supports. This registration process must happen on each end-user device that will utilize the custom functionality. As additional functionalities are added, new components must be deployed, and perhaps, re-registered, to each end-user computer.

For example, assume an end-user is an accounting practice and implements a COTS software application that performs various accounting functions. The accounting field typically requires various best practices and legal mandates that must be followed by the software applications relied on by accounting practices. Further, end-users in the accounting practices may wish to add business rules that are unique to their own practices. To allow for this, the COTS application's vendor might allow for an interface, e.g., ICustomRules. This interface can include a function—ValidateRecord, which takes a parameter of LineItemData and returns ValidationResult

If this COTS software application was purchased by an accounting practice, the practice may want different rule sets, based on the type of a client (e.g., different industry client). For example, the accounting practice supports a medical practice and a landscaping company and processes the following LineItemData:

| | | | | |
|---|---|---|---|---|
| Aspirin | 300 | bottles | $2000 | Tax-exempt |
| Shovel | 1 | each | $50 | Tax-exempt |

If these two line-items were for the medical practice, the first line-item should be accepted, but the second line-item might generate a warning. Likewise, if for the landscaping company, the first-line item might generate a warning while the second would be accepted. Hence, different custom rules would be applicable to the medical practice and landscaping company.

In view of the above, a significant amount of end-user overhead would be required to support different customer domains with different custom rulesets. Prior to running the COTS application, the end-user would have to unregister the last custom component (e.g., using administrator privileges) and register the custom component applicable to another customer being worked on. To solve these issues, the current subject matter may be configured to allow the correct custom components to be automatically deployed to the end-user, hence, eliminating overhead associated with the API (e.g., ActiveX™ API) registration.

In some implementations, the current subject matter can provide a computing system and/or framework along with corresponding processes for automating deployment of computing components that may be related to an operation of one or more internal and/or external software applications installed on one or more user computing devices. The components may include computing functionalities, software applications, graphical user interface components, operating components, query execution components, communication software components, data, metadata, structured content data, unstructured content data, embedded data, nested data, hard disk data, memory card data, cellular telephone computing components, smartphone computing components, graphical data, video data, audio data, zip files, files, memory images, and/or any other data/information. The components may be in various formats, such as source code, object code, text, numerical, alpha-numerical, hierarchically arranged data, table data, email messages, text files, video, audio, graphics, etc.

In some implementations, the current subject matter may perform an automated deployment of computing components on user devices using an envelope (e.g., an ActiveX envelope) that may include any requisite computing components, functionalities, etc., which may be streamed in from one or more external sources (e.g., a repository, a database, a server, etc.). As functionality/component is added, updated, modified, deleted, etc., such updates may be streamed into the envelope. This may allow for instantaneous deployment of new functionality/component while reducing time, total cost of ownership, etc.

The current subject matter's automated deployment of software components may include at least the following phase: an initialization phase and an operation phase. During the initialization phase, the current subject matter may determine whether requisite updates software functionalities/components (e.g., new versions, modification, update, deletion, etc. of existing versions of software functionalities/components) exist and may need to be retrieved from the repository and instantiated on user devices. During operation phase, the current subject matter may proxy the function calls from the third-party applications (that is associated with the functionalities/components being updated) to the extended/custom component functions and returning any results back to the third-party application.

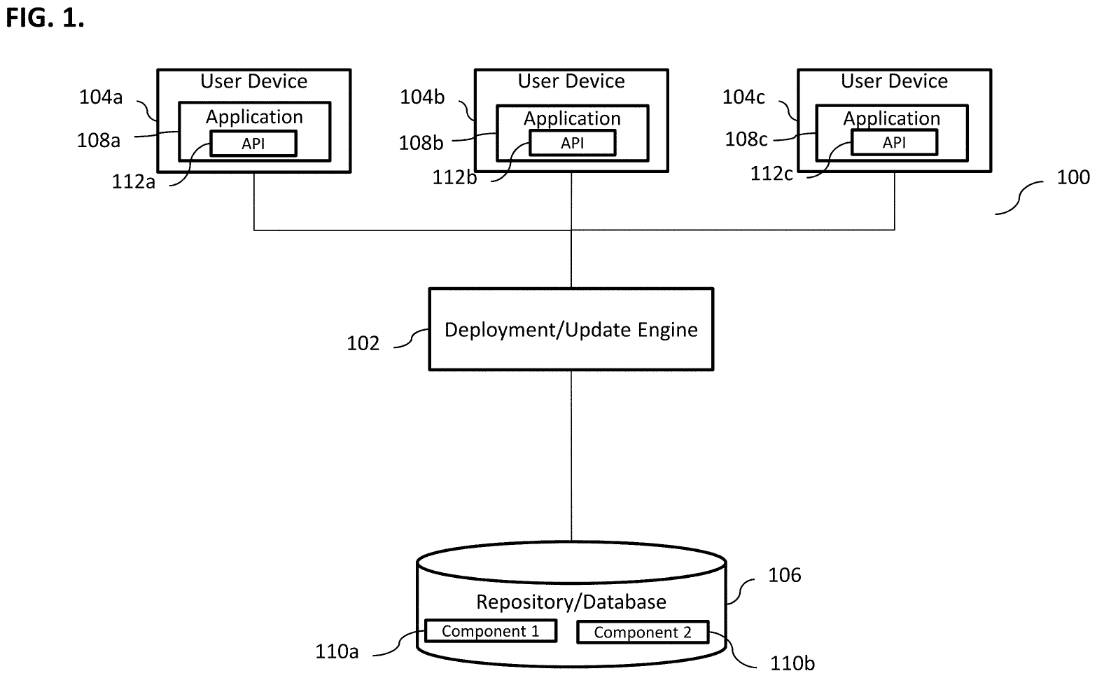

FIG. 1 illustrates an exemplary system 100 for performing automated deployment of software components, according to some implementations of the current subject matter. The system 100 may include a deployment/update engine and/or computing platform 102, one or more user devices 104(a, b, c), a repository/database 106 that may include one or more computing functionalities/components 110(a, b), and a software applications 108(a, b, c) that may be associated with the computing functionalities/components 110 and installed/executed on/by the user devices 104. Devices 102-106 may be communicatively coupled using one or more communications networks. The communications networks may include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

The devices 102-106 may include any combination of hardware and/or software. In some implementations, devices 102-106 may be disposed on one or more computing devices, such as, server(s), database(s), personal computer(s), laptop(s), cellular telephone(s), smartphone(s), tablet computer(s), and/or any other computing devices and/or any combination thereof. In some implementations, the devices 102-106 may be disposed on a single computing device and/or can be part of a single communications network. Alternatively, the devices may be separately located from one another.

A user may access the system 100 via a user device 104. The user device 104 may be used to access and/or execute one or more applications 108 (e.g., email, word processing, etc.), installed thereon, and/or receive an update to one or more functionalities/components of the application 108 that may be deployed on the user device 104. In some implementations, the application 108 may also include an application programming interface (API) 112(a, b, c) that may be used to extend one or more functionalities of the application 108 using functionalities provided components 110, which may be supplied by the engine 102 from the repository 106. By way of a non-limiting example, the application 108 may be Sparx Systems Enterprise Architect (available from Sparx Systems, Creswick, Victoria, Australia), which is a visual modeling and design tool based on the object management group (OMG) unified modeling language (UML). The Enterprise Architect supports design and construction of software systems, modeling business processes, and modeling industry based domains. The API 112 that may be used by the devices 104 may implement Microsoft's ActiveX technology. The application (108) may provide the API 112 that may be used by the respective devices 104 and, by way of a non-limiting example, may implement Microsoft's ActiveX technology. Using the API 112, one or more ActiveX add-ins may be installed on the user devices 104 and may be used during the deployment process. The add-ins may be configured for providing communications between the user devices and the repository 106. Once connection is established, the repository 106 may send a list of custom computing functionalities/components (e.g., applets) that may, for example, include a name and a hash, which may be used for the purposes of authentication and/or to unauthorized access/alternation. The current subject matter may then determine which custom functionalities/components are installed on the user devices 104 for the purposes of determining whether any changes are required. If required functionalities/components are not installed on the user device 104, the current subject matter system may be configured to extract one or more files (e.g., binary files) and/or any other data for the functionality/component from the repository 106 and store it on the user device 104. Then, the functionality/component may be instantiated on the user device 104. In some implementations, the API 112 may act as a proxy between the user device 104 and the repository 106 to allow transmitting/receiving requests/communications and/or functionalities/components between the user device 104 and the repository 106. In that regard, by having API 112 act as a proxy, the functionalities/components no longer need to be ActiveX based and no longer need to be registered.

As shown in FIG. 1, one or more users using devices 104 may access the system 100. The users can be individual users, computing devices, software applications, objects, functions, and/or any other types of users and/or any combination thereof. Upon installing an appropriate API (or any other interface), the user device 104 may generate an instruction/command to the engine 102 to process the request and/or extract data/functionalities/components from one or more the database 106 for installation on the user device 104. The instruction/command can be in a form of a query, a function call, and/or any other type of instruction/command, as discussed below. In alternate, implementations, the instructions/commands may be provided using a microphone (either a separate microphone or a microphone imbedded in the user's device), a speaker, a screen (e.g., using a touchscreen, a stylus pen, and/or in any other fashion), a keyboard, a mouse, a camera, a camcorder, a telephone, a smartphone, a tablet computer, a personal computer, a laptop computer, and/or using any other device. The user device 104 may generate the command automatically and/or manually. Based on the command, the engine 102 may perform initialization, assist in authentication of the user device, obtain list of functionalities/components for installation on the user device, and/or perform any other functions.

The engine 102 may use any means to obtain appropriate data/information for the purposes of installation of functionalities/components. These means may include any means that may include at least one of the following: a query, a function call, a command, an audio instruction (e.g., using a microphone (either a separate microphone or a microphone imbedded in the user device)), a graphical command (e.g., using a touchscreen, a stylus pen, and/or in any other fashion), a text command (e.g., using a keyboard, a mouse, a camera, a camcorder, a telephone, a smartphone, a tablet computer, a personal computer, a laptop computer, and/or using any other device), and/or any other means. The engine 102 may also obtain data from various third party sources. In some implementations, engine 102 may be communicatively coupled to various public and/or private databases that may store various information that may be useful for the purposes of deployment/installation of functionalities/components.

In some implementations, the database 106 may store a plurality of functionalities/components that may be accessed by the engine 102. The database 106 may receive various updates to the functionalities/components and store them for later installation on user devices 104. The updates may include new functionalities/components, updates to existing functionalities/components, deletions of functionalities/components, and/or any other functionalities/components. Once such updates are received, they may be automatically distributed to all user devices 104 that may require receipt, installation, and registration of such updates.

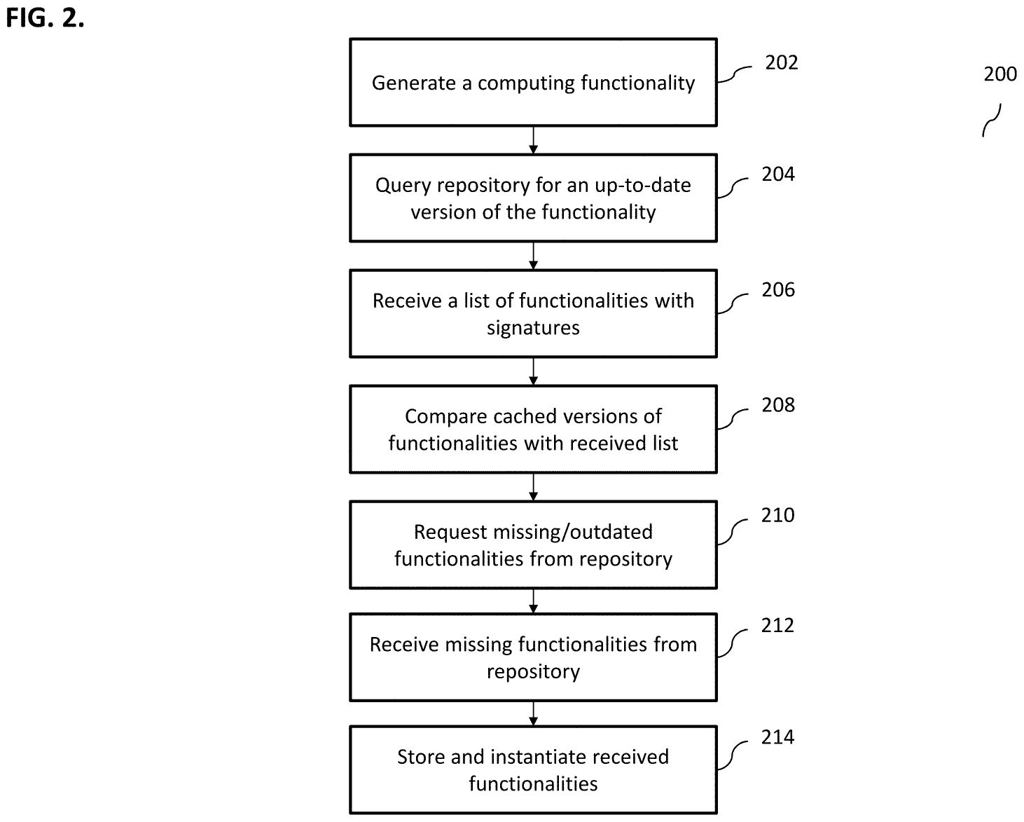

FIG. 2 illustrates an exemplary process 200 performed during initialization of an automated instantiation of computing functionalities/components, according to some implementations of the current subject matter. The process 200 may be performed by the system 100 shown in FIG. 1. In particular, one or more operations of the process 200 may be performed by the engine 102 shown in FIG. 1. At 202, a software application functionality/component may be generated. Such functionality/component may be generated internally and/or by an external software application provider, e.g., third party application provider 108, shown in FIG. 1. The software application 108 may include one or more functionalities/components that may be implemented and/or installed on user devices 104 and may be used for performing various tasks by the user devices 104. The software application 108 may be configured to generate various updates to its functionalities/components and supply them to the system 100 for the implementation/installation on user devices 104. Moreover, the functionalities/components may be stored in the repository 106 to ensure that most up to date functionalities/components are available for installation on user devices 104. The repository 106 may be configured to maintain a list of most up to date functionalities/components that may be available for installation on user devices 104. Depending on the functionalities/components that are installed on the user devices 104, one or more of functionalities/components stored in the repository 106 may be installed and/or updated on the user devices 104.

In some implementations, once the application 108 generates a functionality/component, the application may supply it to the engine 102. At 204, the engine 102 may be configured to query the repository 106 to determine whether the received functionality/component is the most up-to-date functionality/component. In response to the query, a search of the repository 106 may be conducted and the repository may generate a list of available functionalities/components for installation on the user device 104. The list may be supplied to the engine 102, at 206. The functionalities/components may relate to the functionality/component that will be provided to the application 108. Such functionalities/components may be custom components that may be specific to a particular application, operating environment, purpose (e.g., client-specific), etc. Further, the list of functionalities/components may be specific to a particular user device 104 and/or a group of user devices 104. For example, some functionalities/components may be installed on one user device 104, but are not (or cannot be) installed on another user device 104. To ensure that appropriate or valid functionalities/components are being installed on proper user devices 104, the repository 106 may be configured to provide the functionalities/components along with corresponding signatures or hashes that may be used to verify authenticity of the supplied functionalities/components. In some implementations, the engine 102 may perform an authentication process of the functionalities/components using the signatures and/or hashes that are being provided. For example, the engine 102 may compare supplied signatures/hashes with signatures/hashes that may have been cached by the engine 102.

At 208, the engine 102 may perform a comparison of the supplied functionalities/components with any versions of functionalities/components that may have been previously cached by the engine 102. In some implementations, the comparison may determine that one or more versions of the functionalities/components that may have been installed on one or more user devices 104 received modifications and/or is outdated and, thus, may require an appropriate update. Additionally, the engine 102 may determine that one or more functionalities/components that are included in the received list may need to be installed on one or more user devices 104. The engine 102 may then send a request to the repository 106 to obtain missing functionalities/components, at 210.

At 212, the repository 106 may receive the request seeking missing functionalities/components from the engine 102 and respond to the engine 102 with any required functionalities/components. The repository 106 may be configured to supply the missing functionalities/components to the engine 102 upon request and/or automatically, for example, by streaming such functionalities/components upon receiving them (or updates to them) to engine 102.

At 214, once the engine 102 receives the functionalities/components from the repository 106, the engine 102 may be configured to store/cache the functionalities/components. The engine 102 may also be configured to determine which user devices 104 may need to be updated with the received functionalities/components and proceed with instantiation of the received functionalities/components on user devices 104. The engine 102 may also continue caching the functionalities/components until new versions of the functionalities/components are received from the repository 106 (and/or supplied to the engine 102 and/or repository 106 by the application 108).

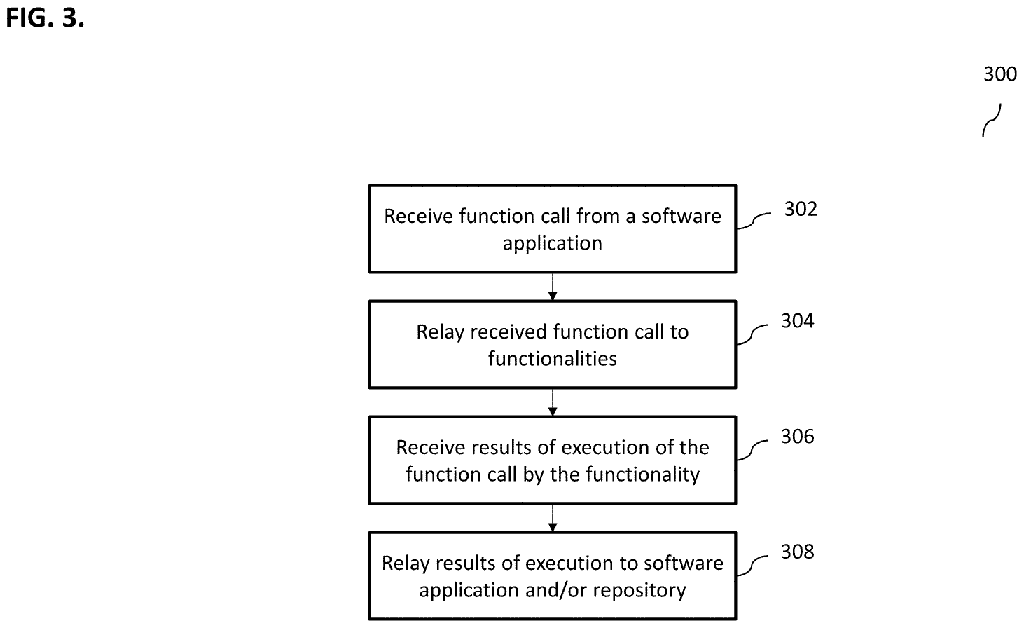

FIG. 3 illustrates an exemplary process 300 performed during an operation phase of the automated instantiation of computing functionalities/components, according to some implementations of the current subject matter. The engine 102 (shown in FIG. 1) may be configured to perform process 300 and act as a proxy between the application 108, via API 112 and the user devices 104 and/or repository 106. The process may be performed triggered upon the user device executing the application 108, which then may expose the application's API 112. The API 112 then calls the engine 102 (and may serve as a proxy with the application 108). Then, the desired custom functionality may be executed.

As the proxy, the engine 102 may be configured to process any function calls between the devices 104, repository 106, and/or application 108. By way of a non-limiting example, such proxy process may include an ActiveX interface call that may be required to extend the Sparx Enterprise Architect product (which may act as the application 108). A function call defined in the API 112 is EA_OnPostNewElement. It may require two parameters: repository and eventProperties, and return a Boolean value. The execution sequence may be as follows. Enterprise Architect (which may correspond to the application 108) may call the EA_OnPostNewElement function supplied by the engine 102. The engine 102, acting as a proxy, may call the custom application 108, passing the repository and eventProperties parameters provided by the application. The custom application 108, performing the enhanced function with the supplied parameters, may return a Boolean value result to the engine 102. The engine 102 may pass the result back to the application.

At 302, the engine 102 may receive a function call from the software application 108. At 304, the engine 102 may be configured to relay the received function call to the respective functionalities/components for which the function call was intended. The engine 102 may transmit the received function call to one or more user devices 104 that have these functionalities/components installed.

In some implementations, the function call may be transmitted by the engine 102 with appropriate parameters. Referring to the ActiveX API example above, the ActiveX API may have an immutable interface contract that may include a list of functions a component may perform, and for each function, a list of typed parameters and return values. This may allow a host software to use “add-ins”. When an add-in software is registered, as part of the registration process, there is a guarantee that the component will comply with the interface specification. The functions/parameters/return lists are ActiveX API contract specific. Some ActiveX contracts, e.g., the interface for Sparx Enterprise Architect, may be limited to a single domain. Other ActiveX interfaces, e.g., Messaging Application Programming Interface for Email (MAPI)) and Digital Imaging and Scanning interface (TWAIN) may be used by multiple host application programs.

In some implementations, the function call may be configured to cause execution of a specific function and/or action by the functionalities/components that may have been instantiated, as a result of the process 200 shown in FIG. 2. Once execution of the function(s)/action(s) is completed by the functionalities/components, the results of the execution may be returned to the engine 102, at 306. In some implementations, the engine 102 may be configured to distinguish between the results of execution of specific functionalities/components and corresponding user devices 104.

At 308, the engine 102 may be configured to relay or transmit received results of execution to the application 108 in response to the received function call. Further, the results may also be cached by the engine 102 for further use.

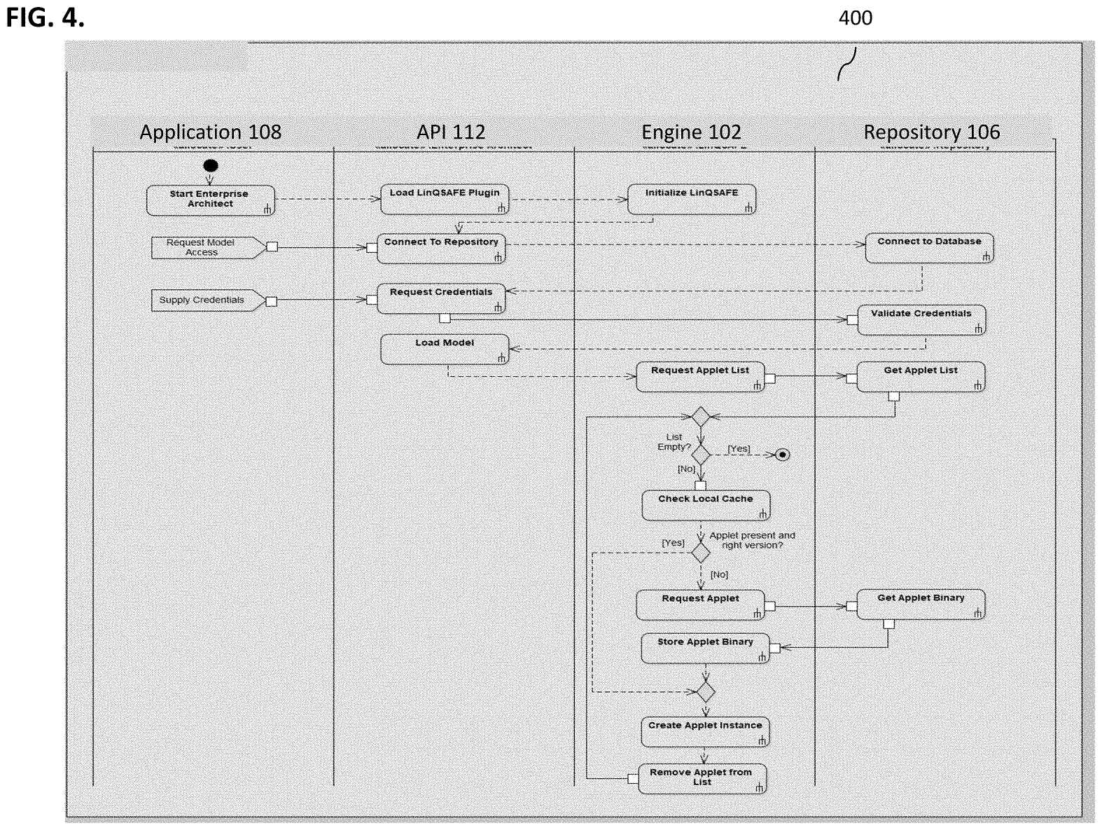

FIG. 4 illustrates an exemplary implementation of functionality/component initialization flow diagram 400, according to some implementations of the current subject matter. The initialization process 400 may begin with the user device 104 creating a runtime instance of the application 108. The application 108 may access the engine 102 (i.e., “LinQSAFE”, as shown in FIG. 4) by loading the API 112 (i.e., “LinQSAFE Plugin”, as shown in FIG. 4) via an Enterprise Architect environment discussed above. Once the engine 102 is initialized, the API 112 may connect to the repository 106. To ensure secure access to the repository 106, the repository 106 may request appropriate credentials (e.g., authentication) from the user device 104. The user device 104 may then supply its credentials via the API 112 to the repository 106. The repository 106 may verify the received user device credentials to authenticate user device 104. If the authentication process fails, the repository may transmit an error message and prevent access to it by the user device 104.

In turn, the API 112 may request a list of functionalities/components (i.e., “Applets” as shown in FIG. 4) that may be available for instantiation on the user devices 104. The request may be transmitted by the engine 102 to the repository 106. In response, the repository 106 may supply the requested list of functionalities/components to the engine 102. The repository 106 may include a list of applets, which may include an applet name, a version, a hash code, a binary code, and/or any other information. The requested list may be used with the current application, as well as a list of users/groups that may be entitled to use each of the applets. By resolving the credentials of a user and/or a group identity, the functionalities/components list may be limited to what a particular end-user/group may be eligible to use. If the repository 106 is required to support multiple host software applications, the contents of applet list may include functionalities/components that may be used on multiple host software applications, and the list may identify particular application(s) that the functionality/component may be used with.

If the list supplied by the repository 106 is empty, the engine 102 may be configured to terminate the process 400. In some implementations, an appropriate message may be transmitted to the user device 104 indicating that no updates and/or new functionalities/components are available for installation. Alternatively, no message is transmitted.

If the supplied list includes one or more functionalities/components that may be available for instantiation on the user device 104, the engine 102 may be configured to access its local cache to determine whether the functionalities/components in the supplied list are the latest versions, correct versions, functionalities/components designated for the specific user device 104, etc. The local cache at engine 102 may be configured to store cached versions of the functionalities/components against which the supplied list may be compared by the engine 102.

If the supplied functionalities/components are cached, are correct versions, etc., the engine 102 may be configured to generate an instance for the functionalities/components for instantiation on the user device 104. The functionality/component for which instance was generated may be removed from the supplied list. This process may be iterated by the engine 102 until all functionalities/components in the list are removed.

If the functionality/component contained in the supplied list has not been previously cached by the engine 102, the engine 102 may generated a request to the repository 106 provide the engine 102 with the functionality/component. The repository 106 may be configured to generate that functionality/component's binary file and provide it to the engine 102, which may, in turn, cache it and use the cached version during iterating process discussed above.

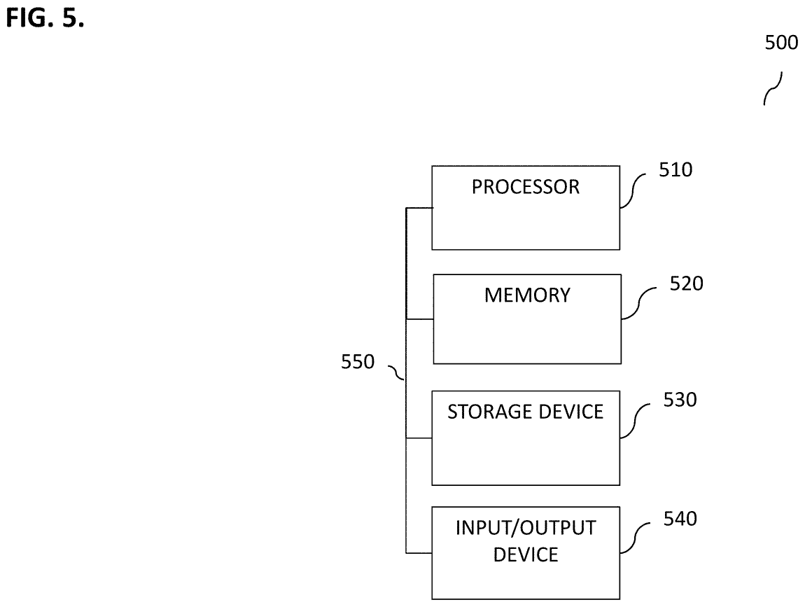

In some implementations, the current subject matter can be configured to be implemented in a system 500, as shown in FIG. 5. The system 500 can include one or more of a processor 510, a memory 520, a storage device 530, and an input/output device 540. Each of the components 510, 520, 530 and 540 can be interconnected using a system bus 550. The processor 510 can be configured to process instructions for execution within the system 500. In some implementations, the processor 510 can be a single-threaded processor. In alternate implementations, the processor 510 can be a multi-threaded processor. The processor 510 can be further configured to process instructions stored in the memory 520 or on the storage device 530, including receiving or sending information through the input/output device 540. The memory 520 can store information within the system 500. In some implementations, the memory 520 can be a computer-readable medium. In alternate implementations, the memory 520 can be a volatile memory unit. In yet some implementations, the memory 520 can be a non-volatile memory unit. The storage device 530 can be capable of providing mass storage for the system 500. In some implementations, the storage device 530 can be a computer-readable medium. In alternate implementations, the storage device 530 can be a floppy disk device, a hard disk device, an optical disk device, a tape device, non-volatile solid state memory, or any other type of storage device. The input/output device 540 can be configured to provide input/output operations for the system 500. In some implementations, the input/output device 540 can include a keyboard and/or pointing device. In alternate implementations, the input/output device 540 can include a display unit for displaying graphical user interfaces.

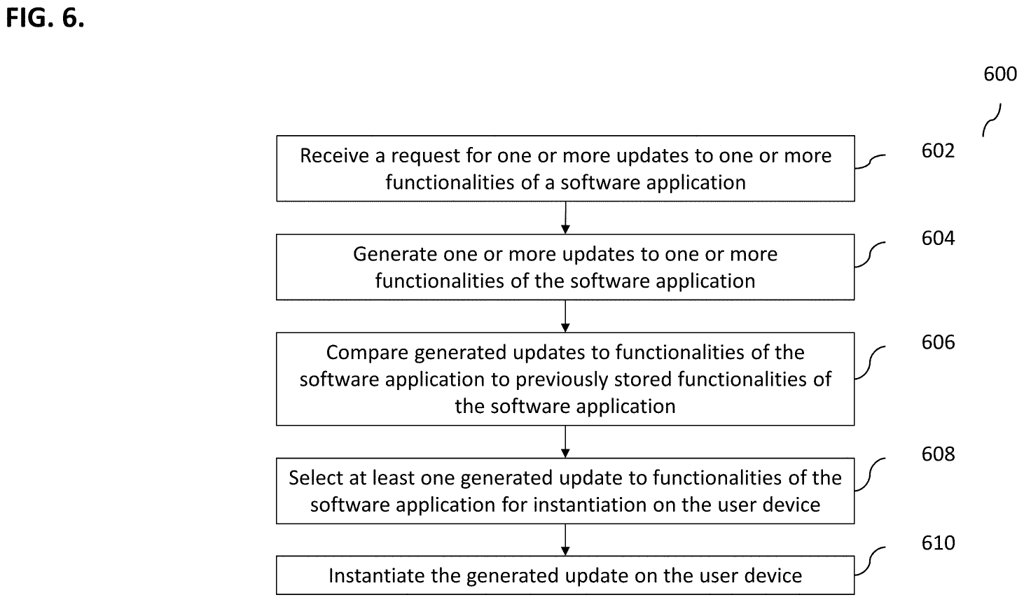

FIG. 6 illustrates an exemplary computer-implemented method 600 for automated instantiation of updates to functionalities/components of software applications, according to some implementations of the current subject matter. The method 600 may be performed by the engine 102 shown in FIG. 1. At 602, a request for one or more updates to one or more functionalities/components of a software application may be received. The software application (e.g., software application 108 as shown in FIG. 1) may be installed and/or operating on at least one user device (e.g., user device 104). At 604, based on the received request, one or more updates to one or more functionalities/components of the software application may be generated. The updates may be generated in accordance with at least one runtime instance associated with the software application, which may be stored by the repository 106 shown in FIG. 1. At 606, the generated updates (e.g., a list of generated updates) to one or more functionalities/components of the software application may be compared to one or more previously stored functionalities/components of the software application. The previously stored functionalities/components may have been cached by the engine 102. At 608, based on the comparison, at least one generated update to functionalities/components of the software application may be selected for instantiation on the user device. At 610, the generated update may be instantiated on the user device.

In some implementations, the current subject matter can include one or more of the following optional features. In some implementations, the method may also include storing the generated update to the functionalities/components of the software application.

In some implementations, at least one repository (e.g., repository 106) may store the one or more updates to functionalities/components of the software application in accordance with a particular model. In some implementations, the comparison may also include determining that at least one generated update to functionalities/components of the software application is not included in one or more previously stored/cached functionalities/components of the software application, requesting generation of the determined update and receiving generated update for instantiation on the user device. The determined update may be generated by the repository in accordance with the model. The repository may generate a binary file associated with the determined update.

In some implementations, the method may also include receiving at least one function call for execution by at least one updated instantiated functionality/component on the user device, executing the instantiated functionality/component on the user device, and transmitting at least one result of the execution of the instantiated functionality on the user device.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving a request for one or more updates to one or more functionalities of a software application, the software application being installed on at least one user device;
generating, based on the received request, one or more updates to one or more functionalities of the software application, the one or more updates being generated in accordance with at least one runtime instance associated with the software application;
comparing the one or more generated updates to one or more functionalities of the software application with one or more previously stored functionalities of the software application;
selecting, based on the comparing, at least one generated update to one or more functionalities of the software application for instantiation on the at least one user device; and
instantiating the at least one generated update on the at least one user device.

2. The method according to claim 1, further comprising storing the at least one generated update to one or more functionalities of the software application.

3. The method according to claim 1, wherein at least one repository stores the one or more updates to one or more functionalities of the software application in accordance with the at least one model.

4. The method according to claim 3, wherein the comparing further comprises
determining that at least one generated update to one or more functionalities of the software application is not included among one or more previously stored functionalities of the software application;
requesting generation of the at least one determined update and receiving generated at least one determined update for instantiation on the at least one user device.

5. The method according to claim 4, wherein the at least one determined update is generated by the at least one repository in accordance with the at least one model.

6. The method according to claim 5, wherein the at least one repository generates a binary file associated with the at least one determined update.

7. The method according to claim 1, further comprising receiving at least one function call for execution by at least one updated instantiated functionality on the user device;
executing the at least one updated instantiated functionality on the user device; and
transmitting at least one result of the execution of the at least one updated instantiated functionality on the user device.

8. A system comprising:
at least one programmable processor; and
a non-transitory machine-readable medium storing instructions that, when executed by the at least one programmable processor, cause the at least one programmable processor to perform operations comprising:
receiving a request for one or more updates to one or more functionalities of a software application, the software application being installed on at least one user device;
generating, based on the received request, one or more updates to one or more functionalities of the software application, the one or more updates being generated in accordance with at least one runtime instance associated with the software application;
comparing the one or more generated updates to one or more functionalities of the software application with one or more previously stored functionalities of the software application;
selecting, based on the comparing, at least one generated update to one or more functionalities of the software application for instantiation on the at least one user device; and
instantiating the at least one generated update on the at least one user device.

9. The system according to claim 8, wherein the operations further comprise storing the at least one generated update to one or more functionalities of the software application.

10. The system according to claim 8, wherein at least one repository stores the one or more updates to one or more functionalities of the software application in accordance with the at least one model.

11. The system according to claim 10, wherein the comparing further comprises
determining that at least one generated update to one or more functionalities of the software application is not included among one or more previously stored functionalities of the software application;
requesting generation of the at least one determined update and receiving generated at least one determined update for instantiation on the at least one user device.

12. The system according to claim 11, wherein the at least one determined update is generated by the at least one repository in accordance with the at least one model.

13. The system according to claim 12, wherein the at least one repository generates a binary file associated with the at least one determined update.

14. The system according to claim 8, wherein the operations further comprise receiving at least one function call for execution by at least one updated instantiated functionality on the user device;
executing the at least one updated instantiated functionality on the user device; and
transmitting at least one result of the execution of the at least one updated instantiated functionality on the user device.

15. A computer program product comprising a non-transitory machine-readable medium storing instructions that, when executed by at least one programmable processor, cause the at least one programmable processor to perform operations comprising:
receiving a request for one or more updates to one or more functionalities of a software application, the software application being installed on at least one user device;
generating, based on the received request, one or more updates to one or more functionalities of the software application, the one or more updates being generated in accordance with at least one runtime instance associated with the software application;
comparing the one or more generated updates to one or more functionalities of the software application with one or more previously stored functionalities of the software application;
selecting, based on the comparing, at least one generated update to one or more functionalities of the software application for instantiation on the at least one user device; and
instantiating the at least one generated update on the at least one user device.

16. The computer program product according to claim 15, wherein the operations further comprise storing the at least one generated update to one or more functionalities of the software application.

17. The computer program product according to claim 15, wherein at least one repository stores the one or more updates to one or more functionalities of the software application in accordance with the at least one model.

18. The computer program product according to claim 17, wherein the comparing further comprises
determining that at least one generated update to one or more functionalities of the software application is not included among one or more previously stored functionalities of the software application;
requesting generation of the at least one determined update and receiving generated at least one determined update for instantiation on the at least one user device.

19. The computer program product according to claim 18, wherein the at least one determined update is generated by the at least one repository in accordance with the at least one model.

20. The computer program product according to claim 19, wherein the at least one repository generates a binary file associated with the at least one determined update.

21. The computer program product according to claim 15, wherein the operations further comprise
receiving at least one function call for execution by at least one updated instantiated functionality on the user device;
executing the at least one updated instantiated functionality on the user device; and
transmitting at least one result of the execution of the at least one updated instantiated functionality on the user device.
